(19) United States
(12) Patent Application Publication
(10) Pub. No.: US 2025/0307115 A1
(43) Pub. Date: Oct. 2, 2025

(54) METHODS AND APPARATUS TO MANAGE DEBUGGING INTERFACES OF COMPUTING DEVICES

(71) Applicant: Texas Instruments Incorporated, Dallas, TX (US)

(72) Inventors: Kristopher Ryan Burney, Dallas, TX (US); Anand Kumar G, Bengaluru (KA); Prakhar Verma, Bengaluru (IN); Praveen Kumar N, Bengaluru (IN); Ruchi Shankar, Bengaluru (IN); Peter Wongeun Chung, Frisco, TX (US)

(21) Appl. No.: 18/621,032

(22) Filed: Mar. 28, 2024

(51) Int. Cl. G06F 11/36; G06F 21/44

(52) U.S. Cl. CPC G06F 11/362; G06F 21/44

(57) ABSTRACT

Systems, apparatus, articles of manufacture, and methods are described to manage debugging interfaces of computing device. An example apparatus includes first memory configured to store a debug authentication status; a processor; second memory storing instructions that, when executed, cause the processor to: check the debug authentication status in the first memory; perform an authentication procedure in response to determining that the debug authentication status stored in the first memory does not indicate that debug is allowed; and set the debug authentication status in the first memory to indicate that debug is allowed in response to a successful performance of the authentication procedure.

### FIELD OF THE DISCLOSURE

This disclosure relates generally to computing devices and, more particularly, to methods and apparatus to manage debugging interfaces of computing devices.

### BACKGROUND

Computing devices, such as microcontroller units (MCU), often include interfaces that provide a level of access for debugging. For example, a debug interface may provide access to low level functions, parameters, settings, programmability, and other options and tools that are not accessible to a general user of the device. The debug interface may be utilized to program a device such as an MCU. For example, an application may be installed on the MCU via the debug interface. The debug interface may provide access to debugging information (e.g., error messages, exception information, internal parameters, variable states, etc.) for the application and/or the operating software of the MCU.

### BRIEF DESCRIPTION OF THE DRAWINGS

FIG. 1 is a flowchart of an example process to authenticate a debugging interface.

FIG. 2 is a block diagram of an example computing device.

FIGS. 3-4 are flowcharts representative of example machine-readable instructions and/or example operations that may be executed, instantiated, and/or performed by example programmable circuitry to implement the computing device of FIG. 2.

FIGS. 5-6 illustrate an example structure of a configuration.

FIG. 7 illustrates an example configuration.

FIGS. 8-9 are flowcharts of example operations to authenticate a debug host for debugging a computing device.

FIG. 10 illustrates example graphical user interfaces for authenticating a debugging host.

FIG. 11 is a block diagram of an example processing platform including programmable circuitry structured to execute, instantiate, and/or perform the example machine-readable instructions and/or perform the example operations of FIG. 3 to implement the device of FIG. 2.

FIG. 12 is a block diagram of an example implementation of the programmable circuitry of FIG. 11.

FIG. 13 is a block diagram of another example implementation of the programmable circuitry of FIG. 11.

FIG. 14 is a block diagram of an example software/firmware/instructions distribution platform (e.g., one or more servers) to distribute software, instructions, and/or firmware (e.g., corresponding to the example machine-readable instructions of FIG. 3) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### SUMMARY

For managing debugging interfaces of computing devices, an example apparatus includes first memory configured to store a debug authentication status; a processor; second memory storing instructions that, when executed, cause the processor to: check the debug authentication status in the first memory; perform an authentication procedure in response to determining that the debug authentication status stored in the first memory does not indicate that debug is allowed; and set the debug authentication status in the first memory to indicate that debug is allowed in response to a successful performance of the authentication procedure. Other examples are described.

For managing debugging interfaces of computing devices, an example non-transitory computer readable medium includes instructions to check a debug authentication status in a memory. The non-transitory computer readable medium includes instructions to perform an authentication procedure in response to determining that the debug authentication status stored in the memory does not indicate that debug is allowed. The non-transitory computer readable medium includes instructions to set the debug authentication status in the memory to indicate that debug is allowed in response to a successful performance of the authentication procedure. Other examples are described.

For managing debugging interfaces of computing devices, an example method includes checking, via instructions executed by a device, a debug authentication indication of the device. The method includes performing an authentication procedure in response to determining that the debug authentication indication does not indicate that debug is allowed. The method includes setting the debug authentication indication to indicate that debug is allowed in response to a successful performance of the authentication procedure. Other examples are described.

### DETAILED DESCRIPTION

A debug interface may be configured for restricted access. For example, the debug interface may be protected by a password or other credential check before the interface is enabled. In such an example, a technician or other person with the credentials may authenticate to access the debug interface and others without such credentials (e.g., end users of the device, the general public, etc.) may be restricted from accessing the debug interface. Such an arrangement can prevent unauthorized persons from accessing the information of the debug interface, reprogramming the device, etc.

In some environments, a device debug port is locked by an original equipment manufacturer (OEM) when the product is installed in the field. Leaving the debug port open could impose a security risk that could allow a hacker to gain access to the device. However, such OEMs may want to unlock the debug port in a secure way to perform field failure diagnostics, product field service, existing inventory reprogramming, etc. Accordingly, silicon suppliers offer secure debug capabilities using the device hardware and debug tools so that debug port can be unlocked and debug privileges can be gained after the debug authentication process is successful.

In some secure debug solutions, the technician must complete an authentication process each time a device reset is triggered during the debug session. The process can be quite burdensome, especially when a single debug session includes multiple resets. For example, in some systems, a signature must be generated by a remote server and presented during the authentication process each time authentication is performed. In another example system, the technician attempting to access the debug interface must obtain a signing key from an authorized official each time authentication is performed. The technician may need to complete the authentication process after each device reset during the debug session.

Methods and apparatus described herein implement an improved authentication process for access to a debug interface. In some examples, once a successful authentication is performed, a debug authentication status is set in a memory to indicate that debug is allowed. The authentication status may be stored in an area of memory that is not editable (e.g., may be read but not changed) to applications executing on the device or general users of the device. The authentication status may persist (e.g., persistent debug is enabled, a persistent debug connection is enabled, etc.) through device resets (e.g., when a technician resets the device after an error, when a technician resets the device after programming the device, another type of non-power-on reset, etc.). The device may enforce authentication when the access to the debug interface is attempted and the authentication status is not set (e.g., does not indicate that debug is allowed). Conversely, the device may not enforce authentication when the debug authentication status is stored in the memory after a reset (e.g., the debug interface may be allowed without a new authentication occurring). In some examples, the debug authentication status may be cleared from the memory after a failed authentication, after a power cycling of the device, when a technician instructs termination of debugging, etc. In some examples, an authentication process may be performed after a power-on reset even if the debug authentication status is set in memory.

In some examples, multiple cryptographic algorithms may be supported by the device. In some examples, the device may include a configuration file that indicates various aspects of the authentication process (e.g., cryptographic algorithms to be supported, whether authentication persistence is allowed, what type of authentication is to be utilized, etc.). In some examples, the configuration file may indicate a challenge generated based on at least one of: a current date and/or time, an identifier for the device (e.g., a media access control (MAC) address of the device), a random number (e.g., a random number generated by a hardware security manager (HSM)), etc.

In some examples, the boot code includes instructions for managing the debug authentication status. In some examples, an application executing on the device (e.g., instructions that are not the boot code) is prevented from storing the debug authentication status but may be allowed to clear the debug authentication status.

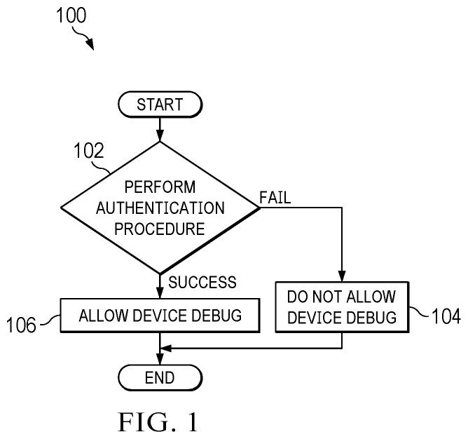

FIG. 1 is a flowchart illustrating an example operation 100 for enabling a debugging interface of a device. The example operation 100 may be performed any time the device is reset. For example, a technician may trigger a reset of the device to initiate the operation 100. Once the operation 100 is triggered, the device performs an authentication procedure (block 102). For example, the device may present a challenge value and request that the technician input a response that corresponds to the challenge value. If the technician inputs no response or the incorrect response (e.g., a failed performance of the authentication procedure), the authentication procedure fails and the device does not allow device debugging (block 104). If the correct response is provided in block 102, the authentication process is successful and the device allows debugging (block 106).

Upon a next reset, the operation 100 requires the technician to perform the authentication procedure again. In other words, while debugging, each time the technician resets the device, they must perform the authentication procedure. For example, when debugging software running on the device, multiple resets may be needed to diagnose errors with the software. In some systems, each time the authentication procedure is performed, the technician must retrieve a new challenge response (e.g., from an external computing system, from a supervisor, etc.). Such repeated authentication may be burdensome for the technician if the technician needs to complete the authentication process after each device reset during a debug session.

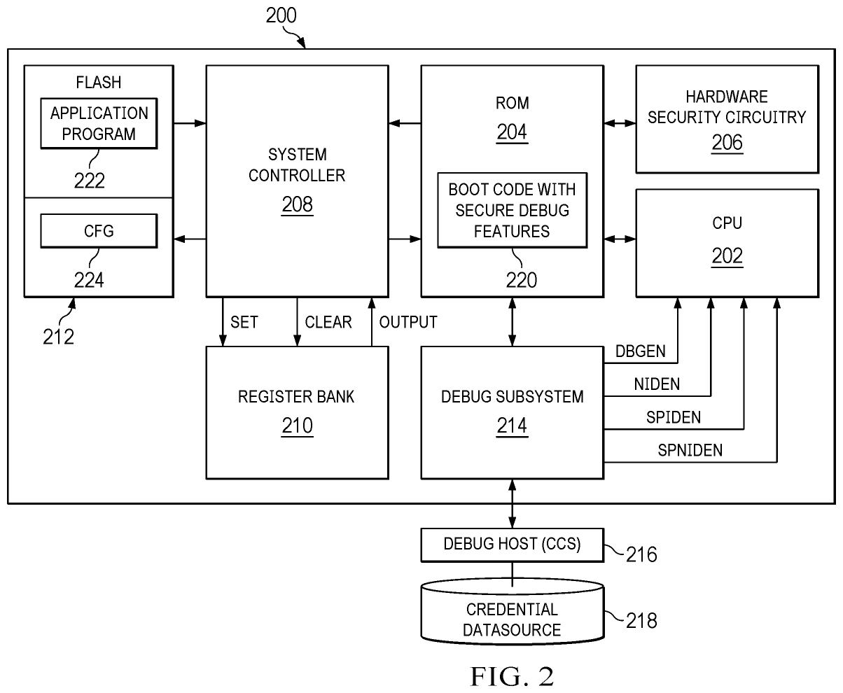

FIG. 2 is a block diagram of an example computing device 200 according to the methods and apparatus described herein. The example computing device 200 includes software to store an authentication status for debugging to allow debugging to remain authorized after a device reset. The example computing device 200 includes a central processing unit (CPU) 202, a read only memory (ROM) 204, a hardware security circuitry 206, a system controller 208, a register bank 210, a flash memory 212, and a debug system 214. In the illustrated example of FIG. 2, the computing device 200 is coupled to an example debug host device 216, which is coupled to a credential data source 218.

Example CPU 202 is processing circuitry to execute software instructions such as example boot code 220 stored in example ROM 204, an example application program 222 stored in flash memory 212, etc. According to the illustrated example, the CPU 202 is an ARM processor. Alternatively, the CPU 202 may be any type of processor.

Example ROM 204 is a read-only memory circuitry coupled to the CPU 202. The read-only memory may be utilized to implement the ROM 204 to prevent modification of the boot code 220 in the field. Alternatively, any other type of memory such as random access memory, flash memory, disk storage, etc. may be utilized to store the boot code 220.

Example hardware security circuitry 206 is circuitry that stores cryptographic keys and implements hardware security to prevent unauthorized access to those cryptographic keys. According to the illustrated example, the hardware security circuitry 206 includes multiple types of cryptographic algorithms such as, for example, circuitry for a true random number generator, circuitry for a secure Hash algorithm, circuitry for public-key authentication, and circuitry for RSA encryption, circuitry for elliptic curve cryptography. By including support for multiple algorithms in the hardware security circuitry 206, and administrator of the device 200 can choose among the various algorithms when implementing an authentication approach for access to the debug subsystem 214. Alternatively, all the example hardware security circuitry 206 includes support for multiple algorithms, the hardware security circuitry 206 may include support for a single algorithm and/or any other combination of algorithms. In some implementations, the hardware security circuitry 206 may alternatively be implemented by software to implement security algorithms such as software stored in the ROM 204 and/or software stored in the flash 212.

The example system controller 208 is circuitry to interface with the various types of memory of the device 200, including the ROM 204. The example register bank 210, and the example flash memory 212. System controller 208 controls and/or restricts the type of operations that may be performed by software from the ROM 204 and the flash memory 212. The example system controller 208 allows the execution of the boot code 220 in the ROM 204 to read, write, and clear a debug authentication status in the example register bank 210. However, the example system controller 208 only allows the application to 222 in the flash memory 212 to read or clear the debug authentication status. In other words, the example system controller 208 restricts, prevents, blocks, etc. the application program 222 from setting the debug authentication status in the register bank 210. By preventing the application program 222 or any other software from the flash memory 212 for writing the debug authentication status, the system controller 208 limits the setting of the debug authentication status to the boot code 220.

The example register bank 210 includes at least one memory register for storing a debug authentication status. The example debug authentication status indicates whether or not a successful authentication process has been completed and, therefore, whether debugging of the device 200 is to be allowed without requiring a further authentication process. The register bank 210 may include storage that is capable of persistent storage during a device reset, such as non-volatile memory, flash memory, etc. The register bank 210 may alternatively be any other type of memory and/or store any other size or amount of information. For example, the register bank 210 may store a result of a previous authentication process, a response to a previous authentication status (e.g., a submitted password or challenge parameter), a history of authentication, etc.

System controller 208 may be configured to perform an authentication process at the beginning or before beginning a debug session. The authentication process may include a challenge-response process. Upon successful completion of the authentication process, system controller 208 can store an indication of the successful authentication process in the register bank 210. An indication of a successful authentication process stored in the register bank 210 may include one or more flags, one or more status bits, the credentials from the successful authentication process, and/or some other indication that a success authentication process has occurred.

The example flash memory 212 is flash memory for storing, among other things, the application 222 and a configuration 224. Alternatively, the flash memory 212 may be any type of storage such as disk storage, random access memory, read only memory, etc. According to the illustrated example, the flash memory 212 is divided into two portions: a primary portion in which the application 222 is stored and a non-main section in which the configuration 224 is stored. For example, the non-main section of the flash memory 212 may be protected memory that is restricted for access.

The example application 222 is a program installed by an original equipment manufacturer (OEM) that sells the device 200. For example, the application 222 may be software that implements an intended function of the device 200. Alternatively, the application 222 may be any type of software such as, for example, an operating system, a user program, and/or any number or combination of software types.

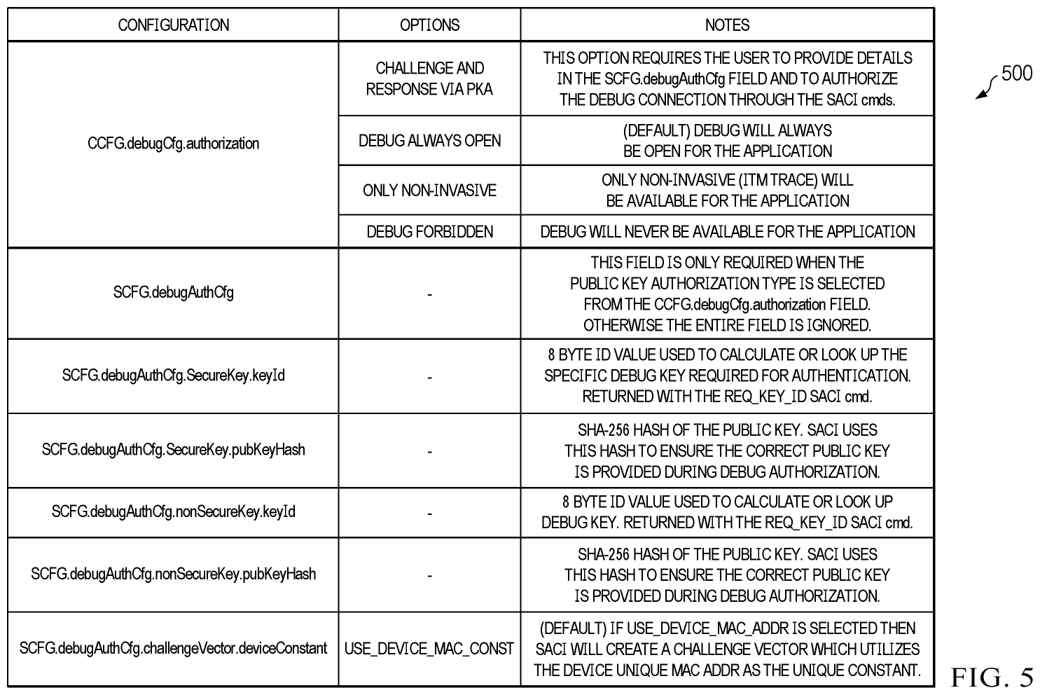

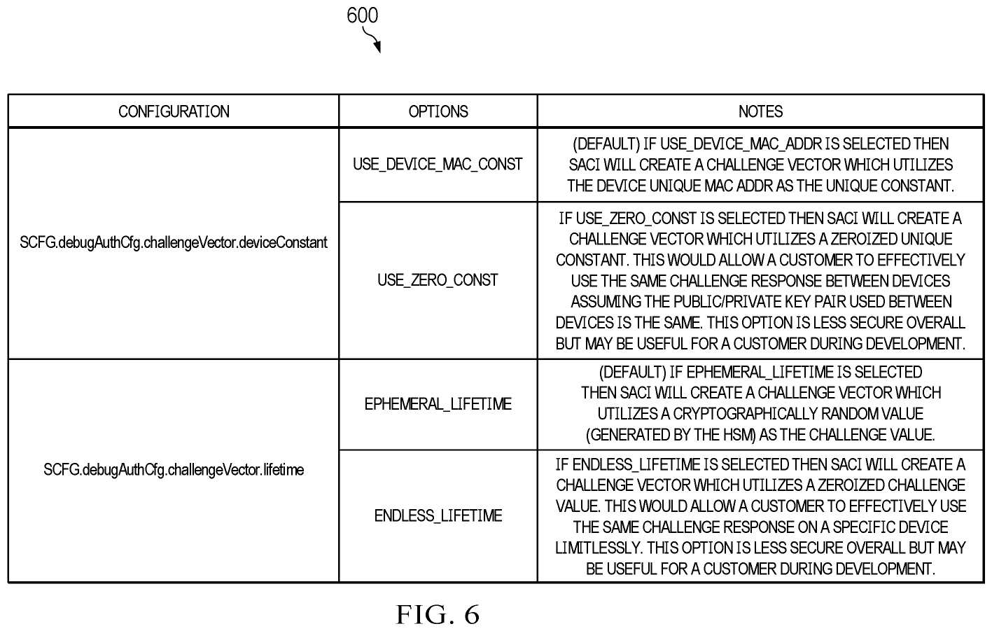

The example configuration 224 is a configuration file that includes settings for configuring the debugging interface provided by the debug subsystem 214. The configuration 224 may include settings/parameters for configuring a challenge and response authentication for the debugging interface, for configuring the type of debugging persistence, for configuring what level of control the application 222 may have over the debugging, etc. Further details of settings that may be included in the configuration 224 are described in conjunction with FIGS. 5-6.

The debug subsystem 214 is circuitry that provides application programming interfaces (APIs) to enable an external device/user to debug, analyze, monitor, etc. the operation and state of the device 200 and the software (e.g., the application 222) executing on the device 200. The debug system 214 interfaces the external device (e.g., the debug host 216) with the boot code 220 executing on the device 200. The example debug subsystem 214 may send signals to the CPU 202 including DBGEN, NIDEN, SPIDEN, SPNIDEN that are bits that may be sent to the CPU 202 to indicate what type of debugging is to be allowed and/or enabled (or not allowed and/or disabled). For example:

If DBGEN is Low, then no invasive debug must be permitted.

If NIDEN is Low and DBGEN is Low, then no debug is permitted.

If NIDEN is High and DBGEN is High, then invasive and non-invasive debug are permitted.

If SPIDEN is Low, then no secure invasive debug must be permitted.

If SPNIDEN is Low and SPIDEN is Low, then no secure debug is permitted.

If SPNIDEN is High and SPIDEN is High, then invasive and non-invasive secure debug is permitted.

While example signals sent from the debug subsystem 214 are described, any other signals and/or types of signals and/or interfaces may be included in the debug subsystem 214.

The example debug host 216 is a computing device external to the device 200 and utilized by a technician to perform debugging and/or any other analysis by interfacing with the debug subsystem 216 of the device 200. For example, the debug host 216 may be a laptop computer, a personal computer, an embedded computing device, etc.

The example credential datastore 218 is a database that correlates challenge prompts and valid responses that may be accessed by a technician debugging the device 200. According to the illustrated example, the technician may access the credential datastore 218 by accessing a user interface from the debug host 216. Alternatively, the credential datastore 218 may be accessed in any other manner. For example, the technician may obtain a challenge response, credential, password, key, certificate, etc. by contacting a person who has access to the credential datastore 218. While a credential datastore 218 is included in the example of FIG. 2, alternate systems may manage credentials in any other manner. For example, a system may include an algorithm or software that may be utilized for determining a valid response/credential, a technician may simply know a valid response (e.g., a password or username/password combination), a technician may contact a device manufacturer to request a valid response/credential, etc.

In operation, the configuration 224 and the application 222 are loaded on the device 200. For example, an original equipment manufacturer (OEM) may load the configuration 224 and the application 222 on the device 200 prior to the device 200 being deployed in the field. The configuration 224 indicates the type of debugging authentication and persistence that is authorized. During operation of the device 200, a technician may prepare to start debugging by communicatively coupling the debug host 216 with the debug subsystem 214 of the device 200. The boot code 220 determines if debugging is already authorized by checking for a stored authentication status in the register bank 210. If the authentication status is stored, the boot code 220 enables debugging (e.g., causes the debug subsystem 214 to enable DBGEN and a combination of NIDEN, SPIDEN, and/or SPNIDEN corresponding to a type of debugging (e.g., invasive or non-invasive) that is configured by the configuration file). Alternatively, if the authentication status is not stored, the boot code 220 causes a prompt to be presented to the technician requesting authentication to enable debugging. If the technician provides a valid response, the boot code 220 causes debugging to be enabled and stores the authentication status in the register bank 210 to persist the enablement of the debugging.

While an example manner of implementing the device 200 is illustrated in FIG. 2, one or more of the elements, processes, and/or devices illustrated in FIG. 2 may be combined, divided, re-arranged, omitted, eliminated, and/or implemented in any other way. Further, the boot code 220 and/or the application 222, may be implemented by hardware alone or by hardware in combination with software and/or firmware. Thus, for example, any of the boot code 22 and/or the application 222, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example device 200 of FIG. 2 may include one or more elements, processes, and/or devices in addition to, or instead of, those illustrated in FIG. 2, and/or may include more than one of any or all of the illustrated elements, processes and devices.

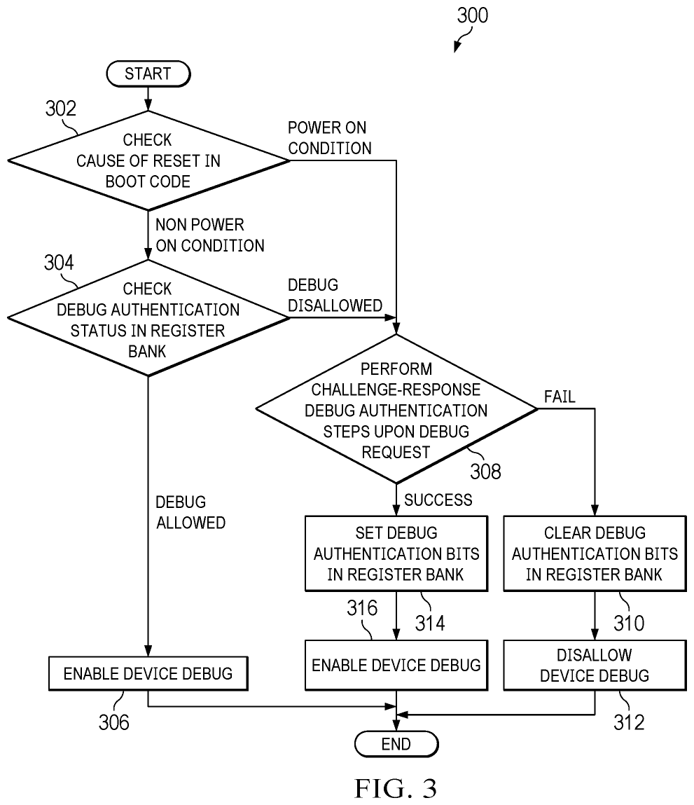

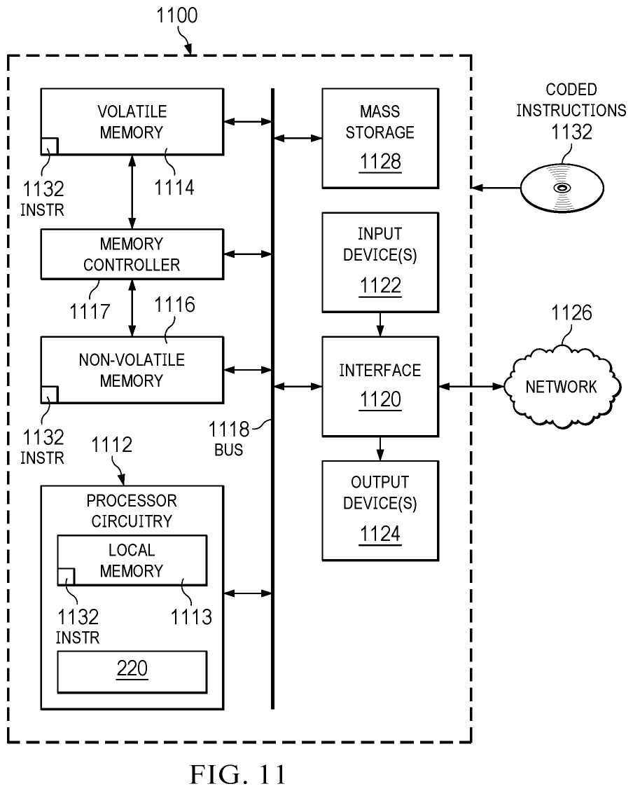

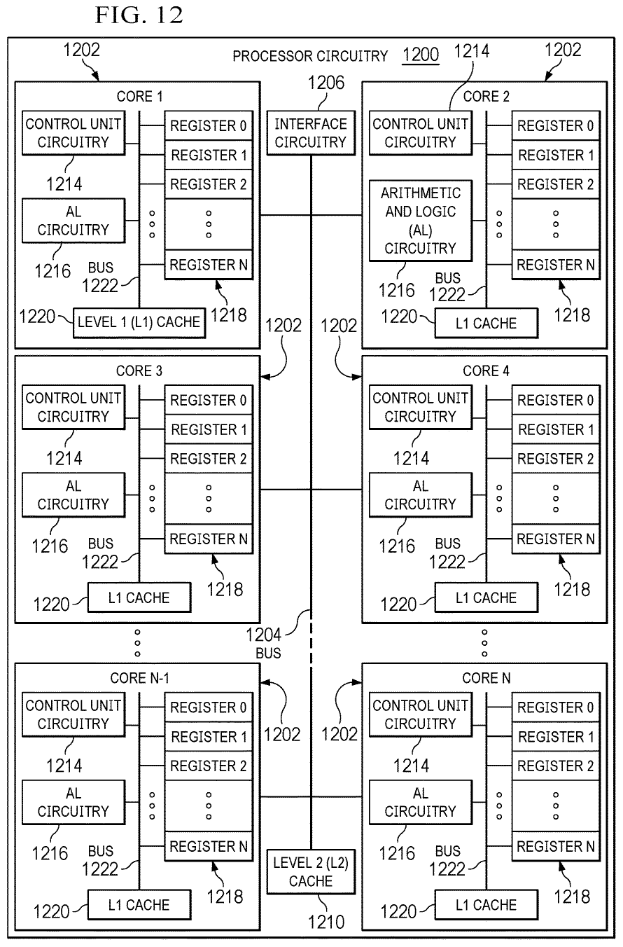

A flowchart representative of example machine-readable instructions, which may be executed by programmable circuitry to implement and/or instantiate the device 200 of FIG. 2 and/or representative of example operations which may be performed by programmable circuitry to implement and/or instantiate the device 200 of FIG. 2, is shown in FIG. 3. The machine-readable instructions may be one or more executable programs or portion(s) of one or more executable programs for execution by programmable circuitry such as the programmable circuitry 1112 shown in the example processor platform 1100 described below in connection with FIG. 11 and/or may be one or more function(s) or portion(s) of functions to be performed by the example programmable circuitry (e.g., an FPGA) described below in connection with FIGS. 12 and/or 13. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3, many other methods of implementing the example device 200 may alternatively be used. For example, the order of execution of the blocks of the flowchart(s) may be changed, and/or some of the blocks described may be changed, eliminated, or combined. Any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices. The parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, Csharp, Perl, Python, JavaScript, HyperText Markup Language (HTML), Structured Query Language (SQL), Swift, etc.

As mentioned above, the example operations of FIG. 3 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 3 is a flowchart representative of example machine-readable instructions and/or example operations 300 that may be executed, instantiated, and/or performed by programmable circuitry to control the authorization of debugging on the device 200. The example machine-readable instructions and/or the example operations 300 of FIG. 3 begin when a determination is to be made if debugging is to be enabled/authorized. For example, the operations 300 may be performed each time the device 200 is reset, each time a request for enabling debugging is received, etc. According to the illustrated example, the boot code 220 determines the cause of a reset (block 302). If the reset was a power on condition (e.g., after a power-cycle), control proceeds to block 308 to perform debug authentication (e.g., debugging is not automatically allowed after a power reset). If the reset was a non-power on condition (e.g., a reset triggered by the technician while debugging), the boot code 220 checks a debug authentication status in the register bank 210 (block 304).

If the debug authentication status stored in the register bank 210 indicates that debugging is disallowed or not allowed, control proceeds to block 308 to perform debug authentication. If the debug authentication status stored in the register bank 210 indicates that debugging is allowed, the boot code 220 causes the debug subsystem 216 to enable debugging (block 306). Block 306 allows for the boot code 220 to bypass a challenge-response authentication process. The process 300 then ends.

Returning to block 308, the boot code 220 performs challenge-response (or any other authentication) debug authentication steps (block 308). If the debug authentication is not successful, the boot code 220 clears the debug authentication status stored in the register bank 210 (block 310) and disallows device debugging (block 312). If the debug authentication is successful, the boot code 220 sets the debug authentication status in the register bank 210 (e.g., sets a debug authentication bit) (block 314) and enables device debugging (block 316). Additional example details of challenge-response debug authentication can be found in commonly assigned U.S. Patent Application Publication No. 2021/0109579, entitled “Methods and Apparatus to Create a Physically Unclonable Function,” filed Dec. 22, 2020, which is incorporated by reference in its entirety.

Accordingly, the boot code 220 facilitates persisting of debug authentication following a device reset that is not a power on reset (e.g., a technician does not need to re-authenticate each time a device is reset).

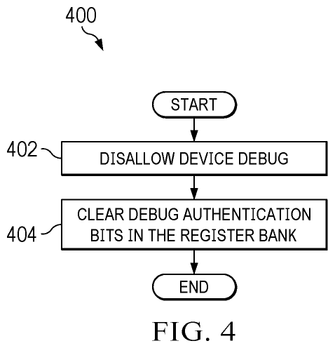

FIG. 4 is a flowchart illustrating example operations 400 that may be performed by the boot code 220 during a device power on. When the device 200 is powered on, the boot code 220 may automatically disallow any debugging (e.g., if it was previously enabled) (block 402) and may clear the debug authentication bits stored in the register bank 210 (block 404). Accordingly, a device power cycle or power off may be sufficient for a technician to ensure that a debugging session may be terminated (e.g., the debugging interface may not be left open for someone other than the technician to access it).

FIG. 4 depicts an operation for clearing the debug authentication bits during a device power on. The debug authentication bits may also be cleared from the register bank 210 after a failed authentication, after a power cycling of the device, or when a host, application, user, or technician instructs termination of debugging. To clear the debug authentication bits, the device 200 can reset the bits to default setting by clearing one or more flags or deleting the authentication credentials.

FIGS. 5-6 illustrate an example definition for the configuration 224. While example fields that may be included in the configuration 224 are illustrated in FIGS. 5-6, any other fields and/or parameters may be utilized to instruct the boot code 220 regarding how debugging is to be enabled and persisted and/or the type of authentication required to enable debugging.

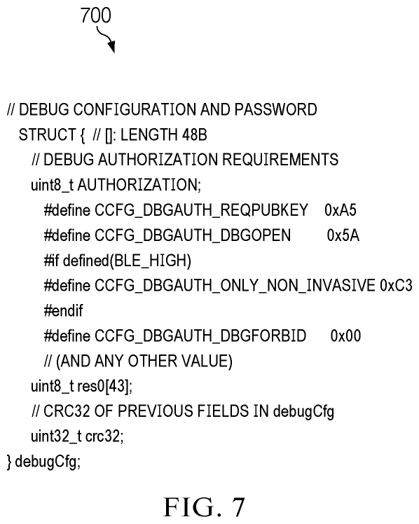

FIG. 7 illustrates an example implementation 700 of the configuration 224. According to the illustrated example, the configuration 700 of FIG. 7 is implemented by a struct object that includes parameters for configuring the state of the debugging.

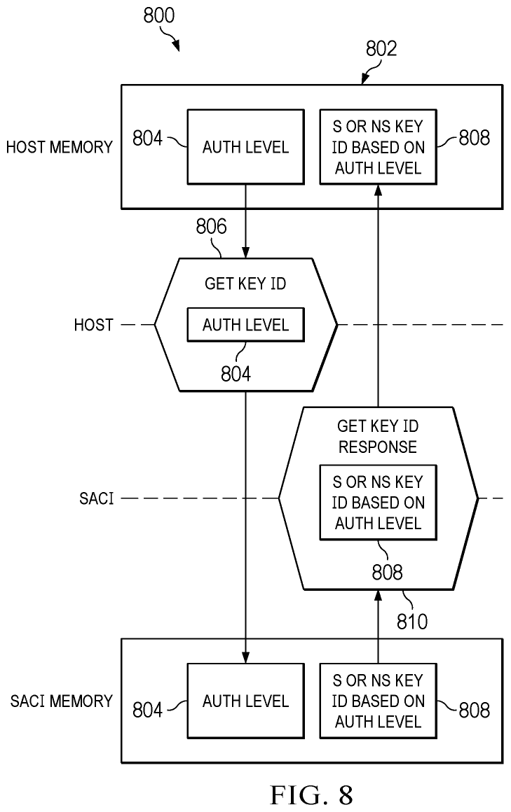

FIG. 8 is a flowchart of example operations 800 for performing secure debug authentication. According to the illustrated example, the example debug host 216 includes a host memory 802 that stores an indication of a requested authorization level 804 that is desired to be utilized. For example, the authorization level 804 may indicate that invasive debugging is requested or non-invasive debugging is desired. The example debug host 216 transmits a Get Key ID Request 806 to the device 200. The example Get Key ID Request 806 includes an indication of the requested authorization level 804. The boot code 220 may check a configuration (CCFG) to determine if the debug authorization value is Challenge and Response via PKA and only respond to Get Key ID if the request matches the secure debug using Challenge and Response. The boot code 220 determines the authorization level 804 and returns a key identifier 808 that is based on the authorization level in a Get Key ID Response 810. For example, the boot code 220 may transmit a first key identifier for secure debugging and a second key identifier for non-secure debugging (e.g., the boot code 220 may refer to the debug authorization configuration in the CCFG to lookup and provide a suitable key ID value to the debug host). Other types of key levels may be utilized such as, for example, invasive vs. non-invasive, short-term versus long-term, etc. Accordingly, a technician that is authorized for non-invasive debugging may be authorized to access credentials corresponding to the first key identifier and may be unable to access credentials for the second key identifier to prevent the technician from performing invasive debugging. The debug host 216 stores the key identifier 808 in the host memory 802.

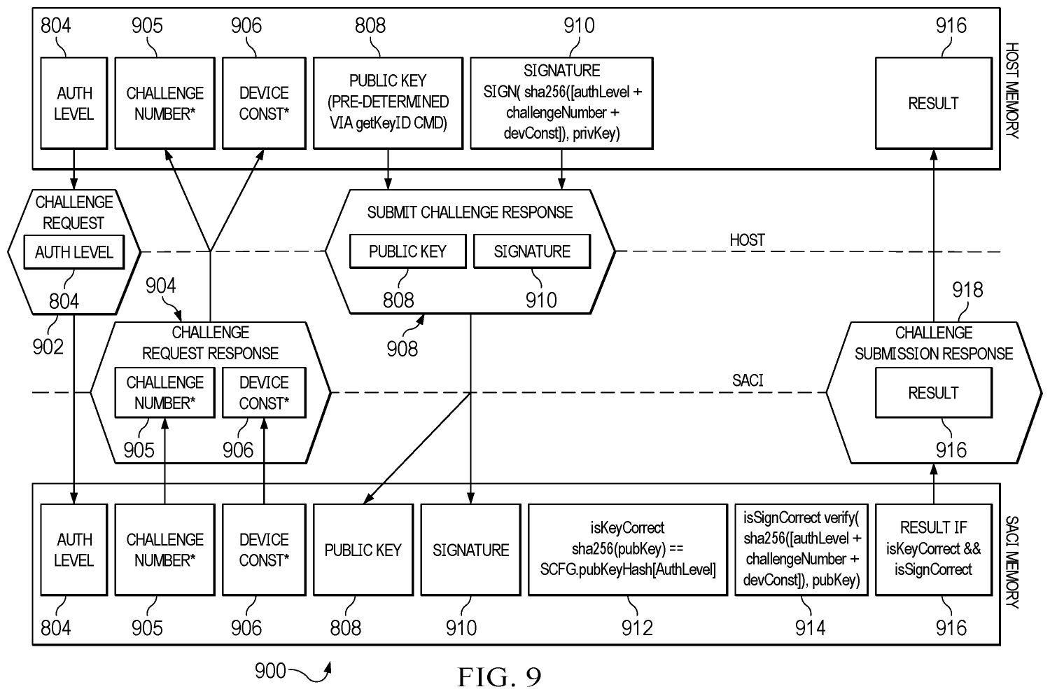

FIG. 9 is a flowchart of example operations 900 that may be performed to authenticate a debugging session. The example debug host 216 transmits a Challenge Request 902 to the device 200. The example Challenge Request 902 includes the authorization level indication 804. The example boot code 220 causes a Challenge Request Response 904 to be transmitted back to the debug host 216.

The example Challenge Request Response 904 includes a challenge number 905 and a device constant 906. For example, the challenge number 905 may be any type of variable number that may add complexity to the challenge (e.g., to ensure that the challenge-response cannot be easily determined by an unauthorized user). For example, the challenge number 905 may be a random number generated by a true random number generator. The example device constant 906 may be any value that is associated (e.g., uniquely associated) with the device 200. For example, the device constant 906 may be a MAC address associated with the device 200. By utilizing the device constant 906, the challenge can be made unique to the device 200. While the example Challenge Request Response 904 includes the challenge number 905 and the device constant 906, any other values or parameters may be utilized in generating a challenge such as, a prompt for a password, a certificate, a key, etc.

The example debug host 216 then transmits a Submit Challenge Response 908 that includes the key 808 from the operation 800 of FIG. 8 and a signature 910. According to the illustrated example, the signature 910 can be determined by the debug host 216 by performing a signing process using a private key on the authorization level 804, the challenge number 905, and the device constant 906. For example, the key provided by the device in response to a Get Key ID command may be used offline by the technician to look up a suitable private and public key pair from a key directory at a credential datasource. In some examples, the signature generation may be performed by a remote entity that a technician is authorized to access and retrieve the authorizing signature 910.

The example boot code 220 then determines if the supplied key 808 is correct (block 912). For example, the boot code 220 may determine if a hash of the public key matches a hash of the public key stored in the configuration 224. The example boot code 220 also determines if the signature is valid by attempting to decrypt the signature (block 914) using a public key and determining if the contained values for authorization level, challenge number, and device constant match the values transmitted to the debug host 216. The boot code 220 generates a result 916 based on the results of block 912 and 914 and transmits the result 916 to the debug host 216 in a Challenge Submission Response 918. Accordingly, if the debug host 216 has access to the proper private key, the debug host 216 is notified that authorization is enabled. Alternatively, if the debug host 216 does not have access to the proper private key and cannot utilize the proper private key to sign the values to generate the signature 910, debugging will not be authorized.

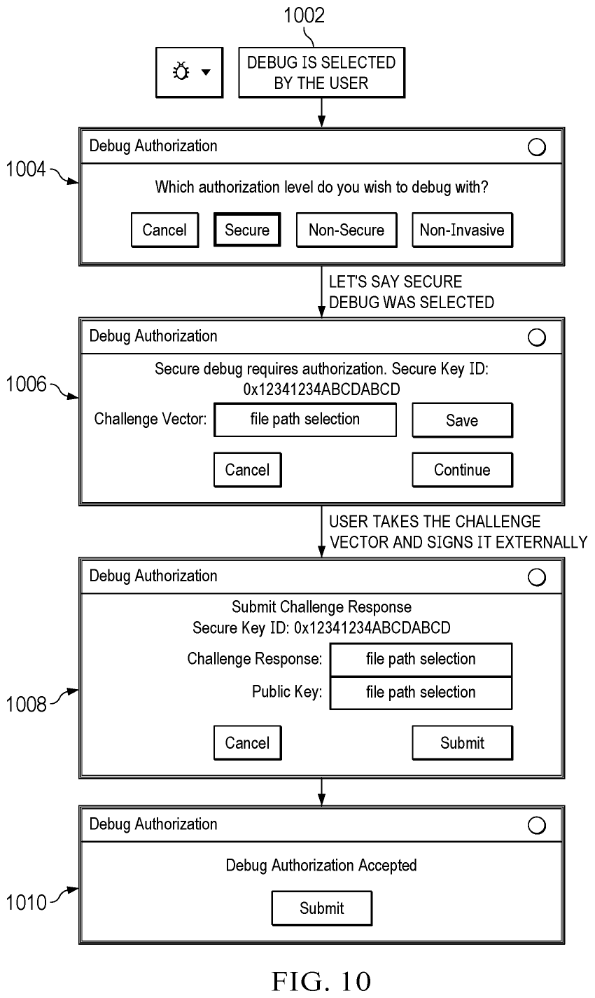

FIG. 10 illustrates example graphical user interfaces that may be presented by the boot code 220 to selectively enable debugging. The example graphical user interfaces are deployed when debugging is selected by a user at block 1002. The first user interface 1004 is displayed to request the user to indicate what type of debugging is requested (e.g., secure debugging, non-secure debugging, non-invasive debugging). When a user selects secure debugging, a second user interface 1006 is presented to provide the user with the secure key identifier and a challenge vector (e.g., a set of parameters/values provided by the device 200). The user has the challenge vector signed (e.g., using an external computing device). The user is presented with a third user interface 1008 where the user can provide the challenge response (e.g., the signature) and a valid public key. If the boot code 220 determines that the challenge response is valid, a fourth user interface 1010 is presented to indicate that debugging has been authorized.

FIG. 11 is a block diagram of an example programmable circuitry platform 1100 structured to execute and/or instantiate the example machine-readable instructions and/or the example operations of FIG. 3 to implement the device 200 of FIG. 2. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. The programmable circuitry 1112 may be implemented by one or more semiconductor based (e.g., silicon based) devices. In this example, the programmable circuitry 1112 implements the boot code 220 of FIG. 2.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1132, which may be implemented by the machine-readable instructions of FIG. 3, may be stored in the mass storage device 1128, in the volatile memory 1114, in the non-volatile memory 1116, and/or on at least one non-transitory computer readable storage medium such as a CD or DVD which may be removable.

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIG. 3 to effectively instantiate the circuitry of FIG. 2 as logic circuits to perform operations corresponding to those machine-readable instructions. In some such examples, the circuitry of FIG. 2 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine-readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine-readable instructions and/or operations represented by the flowcharts of FIG. 3.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. The first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer-based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those described herein. A GPU, DSP and/or other programmable device can also be an accelerator. Accelerators may be on-board the microprocessor 1200, in the same chip package as the microprocessor 1200 and/or in one or more separate packages from the microprocessor 1200.

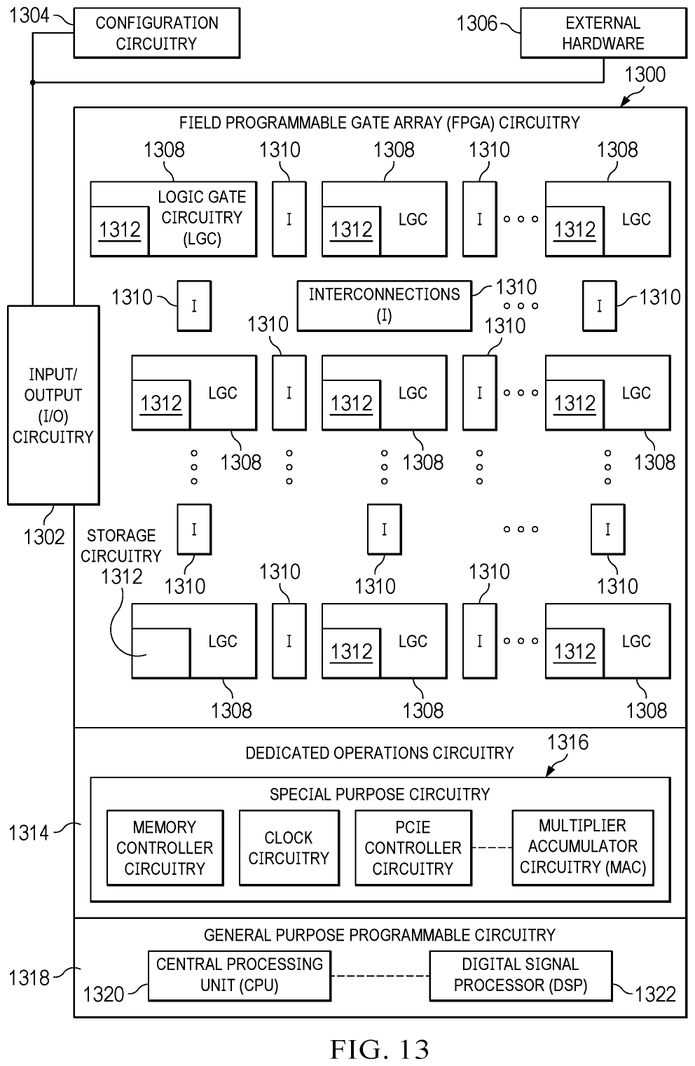

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine-readable instructions. However, once configured, the FPGA circuitry 1300 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine-readable instructions represented by the flowchart of FIG. 3 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine-readable instructions represented by the flowchart of FIG. 3. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 3. As such, the FPGA circuitry 1300 may be configured and/or structured to effectively instantiate some or all of the operations/functions corresponding to the machine-readable instructions of the flowchart of FIG. 3 as dedicated logic circuits to perform the operations/functions corresponding to those software instructions in a dedicated manner analogous to an ASIC. Therefore, the FPGA circuitry 1300 may perform the operations/functions corresponding to the some or all of the machine-readable instructions of FIG. 3 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High-Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to configure or structure the FPGA circuitry 1300 of FIG. 13 to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to configure or structure the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to configure or structure the FPGA circuitry 1300 of FIG. 13 to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to configure or structure the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine-readable instructions of FIGS. 3 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may be present such as a GPU, an XPU, etc., that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may be implemented by combining at least the example microprocessor 1200 of FIG. 12 and the example FPGA circuitry 1300 of FIG. 13. In some such hybrid examples, one or more cores 1202 of FIG. 12 may execute a first portion of the machine-readable instructions represented by the flowchart of FIG. 3 to perform first operation(s)/function(s), the FPGA circuitry 1300 of FIG. 13 may be configured and/or structured to perform second operation(s)/function(s) corresponding to a second portion of the machine-readable instructions represented by the flowchart of FIG. 3, and/or an ASIC may be configured and/or structured to perform third operation(s)/function(s) corresponding to a third portion of the machine-readable instructions represented by the flowchart of FIG. 3.

Some or all of the circuitry of FIG. 2 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1200 of FIG. 12 may execute machine-readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIG. 2 may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

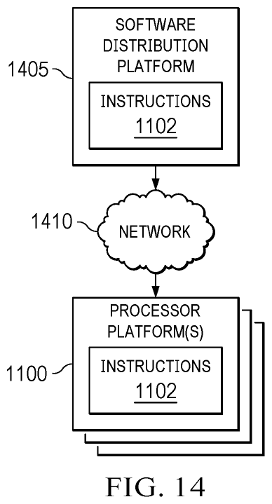

A block diagram illustrating an example software distribution platform 1405 to distribute software such as the example machine-readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine-readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine-readable instructions 1132, which may correspond to the example machine-readable instructions of FIGS. 3, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1132 from the software distribution platform 1405. For example, the software, which may correspond to the example machine-readable instructions of FIG. 3, may be downloaded to the example programmable circuitry platform 1100, which is to execute the machine-readable instructions 1132 to implement the device 200. In some examples, one or more servers of the software distribution platform 1405 periodically offer, transmit, and/or force updates to the software (e.g., the example machine-readable instructions 1132 of FIG. 11) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for case of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real-world imperfections. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather also includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to configure or structure the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been described that manage debugging interfaces of computing devices. Described systems, apparatus, articles of manufacture, and methods improve the efficiency of using a computing device by persisting an authentication status for a debugging interfaces to allow an authentication process to be performed once per debugging session. Described systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been described herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
first memory configured to store a debug authentication status;
a processor;
second memory storing instructions that, when executed, cause the processor to:
check the debug authentication status in the first memory;
perform an authentication procedure in response to determining that the debug authentication status stored in the first memory does not indicate that debug is allowed; and
set the debug authentication status in the first memory to indicate that debug is allowed in response to a successful performance of the authentication procedure.

2. The apparatus of claim 1, wherein the instructions, when executed, cause the processor to allow a debug session in response to a successful performance of the authentication procedure.

3. The apparatus of claim 1, wherein the instructions, when executed, cause the processor to clear one or more bits indicating the debug authentication status in the first memory in response to a failed performance of the authentication procedure.

4. The apparatus of claim 1, wherein the instructions, when executed, cause the processor to disallow a debug session in response to a failed performance of the authentication procedure.

5. The apparatus of claim 1, wherein the instructions, when executed, cause the processor to enable a debug session in response to determining that the debug authentication status stored in the first memory indicates that debug is allowed.

6. The apparatus of claim 1, wherein the instructions, when executed, cause the processor to:
determine that a power-on reset occurred; and
perform the authentication procedure without checking the debug authentication status in response to determining that the power-on reset occurred.

7. The apparatus of claim 1, wherein the instructions, when executed, cause the processor to:
determine that a non-power-on reset occurred; and
check the debug authentication status in the first memory in response to determining that the non-power-on reset occurred.

8. The apparatus of claim 1, wherein the instructions, when executed, cause the processor to perform the authentication procedure based on a media access control (MAC) address associated with the apparatus.

9. The apparatus of claim 8, wherein the instructions cause the processor to perform the authentication procedure based on the MAC address and further based on a value generated by a random number generator.

10. A non-transitory computer readable medium comprising instructions that, when executed, cause a machine to at least:
check a debug authentication status in a memory;
perform an authentication procedure in response to determining that the debug authentication status stored in the memory does not indicate that debug is allowed; and
set the debug authentication status in the memory to indicate that debug is allowed in response to a successful performance of the authentication procedure.

11. The non-transitory computer readable medium of claim 10, wherein the indication includes a bit indicating whether persistent debug is enabled.

12. The non-transitory computer readable medium of claim 10, wherein the instructions are part of a boot code of the machine and the memory further stores an application for execution by the machine.

13. The non-transitory computer readable medium of claim 10, wherein the instructions, when executed, cause the machine to:
determine that a power-on reset occurred; and
perform the authentication procedure without checking the debug authentication status in response to determining that the power-on reset occurred.

14. The non-transitory computer readable medium of claim 10, wherein the instructions, when executed, cause the machine to:
determine that a non-power-on reset occurred; and
check the debug authentication status in the memory in response to determining that the non-power-on reset occurred.

15. The non-transitory computer readable medium of claim 10, wherein the instructions, when executed, cause the machine to perform the authentication procedure based on a media access control (MAC) address associated with the machine.

16. A method comprising:
checking, via instructions executed by a device, a debug authentication indication of the device;
performing an authentication procedure in response to determining that the debug authentication indication does not indicate that debug is allowed; and
setting the debug authentication indication to indicate that debug is allowed in response to a successful performance of the authentication procedure.

17. A method as defined in claim 16, wherein checking the debug authentication indication includes determining that an indication is stored at the device that indicates that a persistent debug connection is disabled.

18. The method of claim 16, further comprising allowing a debug session in response to a successful performance of the authentication procedure.

19. The method of claim 16, further comprising clearing one or more bits indicating the debug authentication indication in response to a failed performance of the authentication procedure.

20. The method of claim 16, further comprising disallowing a debug session in response to a failed performance of the authentication procedure.
